(19) United States
(12) Patent Application Publication
(10) Pub. No.: US 2025/0360718 A1
(43) Pub. Date: Nov. 27, 2025

(54) MAINTENANCE MECHANISM, LIQUID EJECTION APPARATUS, AND MAINTENANCE METHOD FOR LIQUID EJECTION APPARATUS

(71) Applicant: CANON KABUSHIKI KAISHA, Tokyo (JP)

(72) Inventors: KENTA IIMURA, Tokyo (JP); KOHEI FUKUI, Tokyo (JP); SHU KURIHARA, Tokyo (JP); RYOSUKE ARAKI, Kanagawa (JP); TETSUJI SUZUKI, Kanagawa (JP); SEIJI SUZUKI, Kanagawa (JP); MAIKO SHIINA, Tokyo (JP)

(21) Appl. No.: 19/212,996

(22) Filed: May 20, 2025

(30) Foreign Application Priority Data
May 23, 2024 (JP) 2024-084319

(51) Int. Cl. B41J 2/165; B41J 25/00; B41J 25/304

(52) U.S. Cl. CPC B41J 2/16552; B41J 2/16502; B41J 2/16532; B41J 2/16579; B41J 25/001; B41J 25/304; B41J 2002/16558

(57) ABSTRACT

A maintenance mechanism includes a first maintenance unit provided with a plurality of cleaning mechanisms for cleaning a printing head configured to eject a liquid, a second maintenance unit disposed side by side with the first maintenance unit in a transverse direction of the printing head, a support member configured to support the first maintenance unit and the second maintenance unit so as to allow scanning in a longitudinal direction of the printing head, a first positioning member configured to position the printing head at a first cleaning position, and a second positioning member configured to position the printing head at a second cleaning position that is different from the first cleaning position in the transverse direction of the printing head.

### BACKGROUND OF THE INVENTION

### Cross Reference to Priority Application

This application claims the benefit of Japanese Patent Application No. 2024-084319, filed May 23, 2024, which is hereby incorporated by reference herein in its entirety.

### FIELD OF THE INVENTION

The present disclosure relates to a maintenance mechanism, a liquid ejection apparatus, and a maintenance method for a liquid ejection apparatus.

### DESCRIPTION OF THE RELATED ART

In an inkjet printing apparatus, which is a type of liquid ejection apparatus, ink in nozzles of a printing head may dry out, causing the ink to thicken or stick. There is also a situation where paper dust or air bubbles mixed into the nozzles of the printing head cause ejection failure. For this reason, the inkjet printing apparatus generally requires cleaning of the printing head.

As a mode of cleaning, a configuration is known in which an elastic blade is used to wipe the nozzle surface, from which a liquid is ejected, thereby restoring the nozzle surface to its pre-ejection state and maintaining ejection performance. In Japanese Patent Application Publication No. 2024-017388 (Document 1), a cleaning liquid is applied to ink sticking to a nozzle formation surface and having increased adhesion, thereby suppressing the adhesion, and then the ink and the cleaning liquid are removed with a blade. The Document 1 discloses a configuration in which not only wiping with a blade, but also a cleaning operation by applying negative pressure to nozzles is combined for cleaning.

In a case where additional cleaning members are provided to improve cleaning power, a technology is required that allows the cleaning members to be provided without increasing the size of an apparatus.

### SUMMARY OF THE INVENTION

A maintenance mechanism according to one aspect of the present disclosure includes: a first maintenance unit provided with a plurality of cleaning mechanisms for cleaning a printing head configured to eject a liquid; a second maintenance unit provided with a cleaning mechanism different from the cleaning mechanisms provided in the first maintenance unit and disposed side by side with the first maintenance unit in a transverse direction of the printing head; a support member configured to support the first maintenance unit and the second maintenance unit so as to allow scanning in a longitudinal direction of the printing head; a first positioning member configured to position the printing head at a first cleaning position; and a second positioning member configured to position the printing head at a second cleaning position that is different from the first cleaning position in the transverse direction of the printing head.

Further features of the present invention will become apparent from the following description of exemplary embodiments with reference to the attached drawings.

### BRIEF DESCRIPTION OF THE DRAWINGS

FIG. 1 is a schematic cross-sectional view showing an internal configuration of a printing apparatus;

FIG. 2 is a perspective view of a sheet conveyance unit housing in a printing unit;

FIG. 3 is a perspective view showing a elevating and lowering mechanism of a printing head;

FIG. 4 is a perspective view of the printing head;

FIG. 5 is a perspective view of a maintenance tray and the printing head positioned on the maintenance tray;

FIGS. 6A to 6C are schematic views showing an operation of positioning the printing head with respect to the maintenance tray;

FIGS. 7A and 7B are diagrams showing a state upon completion of the positioning of the printing head on the maintenance tray;

FIG. 8 is a top view of the maintenance tray;

FIG. 9 is a diagram showing a pitch between printing head positioning members on a back beam;

FIG. 10 is a perspective view showing a configuration of a maintenance unit;

FIGS. 11A and 11B are cross-sectional side views of a part of the maintenance tray;

FIGS. 12A to 12C are diagrams explaining a configuration of a nozzle formation surface, which is a surface subjected to head cleaning;

FIGS. 13A and 13B are diagrams explaining the maintenance unit;

FIG. 14 is a diagram schematically showing a state where a blade member comes into contact;

FIG. 15 is a perspective view showing a cam mechanism;

FIG. 16 is a diagram showing a state where a cleaning liquid application unit is moved to a contact position with the nozzle formation surface;

FIG. 17 is a diagram showing a state where a first wiper unit is moved to a contact position with the nozzle formation surface;

FIG. 18 is a diagram showing a state where a suction unit is moved to a contact position with the nozzle formation surface;

FIG. 19 is a flowchart showing an example of a head cleaning operation using a first maintenance unit;

FIGS. 20A to 20F are diagrams showing how the maintenance tray moves to a first cleaning position;

FIG. 21 is a flowchart showing an example of a head cleaning operation using a second maintenance unit;

FIGS. 22A to 22G are diagrams showing how the maintenance tray moves to the first cleaning position and a second cleaning position; and

FIG. 23 is a diagram showing a state where the second maintenance unit is moved to a contact position with the nozzle formation surface.

### DESCRIPTION OF THE EMBODIMENTS

A preferred embodiment of the present disclosure will be described in detail below with reference to the accompanying drawings. Note that the following embodiment does not limit the subject matter of the present disclosure, and not all combinations of features described in the following embodiment are necessarily essential to the solution of the present disclosure. Note that the same constituent components will be denoted by the same reference numerals. Furthermore, alphabetical letters may be used to specify individual components in the reference numerals denoting the same components. In a case where no alphabetical letters are used, it is assumed that a common description is given of the components.

### First Embodiment

### <Configuration of Printing Apparatus>

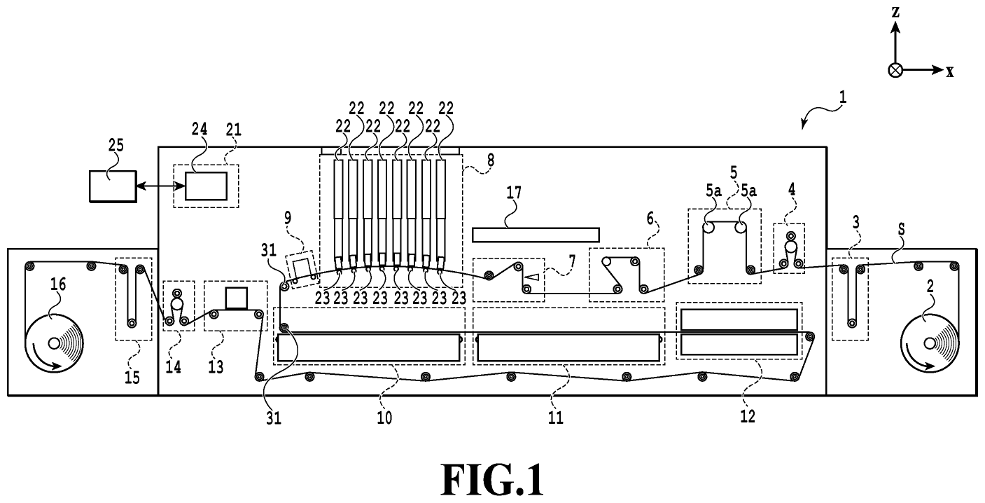

FIG. 1 is a schematic cross-sectional view showing an internal configuration of a printing apparatus 1, which is an example of a liquid ejection apparatus. The printing apparatus 1 is an inkjet printing apparatus configured to eject ink (liquid) by an inkjet method. A top-to-bottom direction in FIG. 1 is defined as a “height direction”, a left-to-right direction in FIG. 1 as a “longitudinal direction”, and a direction orthogonal to the height direction and the longitudinal direction (a direction from the front of paper to the back in FIG. 1) as a “sheet width direction”. The height direction corresponds to a z direction, the longitudinal direction corresponds to an x direction, and the sheet width direction corresponds to a y direction. The longitudinal direction (x direction) refers to the longitudinal direction of the main body of the apparatus. Note that the longitudinal direction of a printing head 22 to be described later is the same direction as the sheet width direction (y direction). The following description is given of a case where the printing apparatus 1 is a printer configured to print images with ink on a continuous sheet wound into a roll, and is a high-speed line printer capable of high-speed printing.

As shown in FIG. 1, the printing apparatus 1 includes the following units inside: an unwinding roll unit 2, a first dancer unit 3, a first main conveyance unit 4, a meandering correction unit 5, a conveyance detection unit 6, a mark sensor unit 7, and a printing unit 8. The printing apparatus 1 also includes the following units downstream of the printing unit 8: a first scanner unit 9, a first drying unit 10, a second drying unit 11, a cooling unit 12, a second scanner unit 13, a second main conveyance unit 14, a second dancer unit 15, a winding roll unit 16, and a maintenance tray 17. A sheet S is conveyed along a sheet conveyance path indicated by the solid line in FIG. 1. The respective units described above perform processing on the sheet S.

The unwinding roll unit 2 is a unit for holding and supplying a continuous sheet wound in a roll. The unwinding roll unit 2 is configured to store the unwound roll and pull out and supply the sheet S. Although one roll can be stored in FIG. 1, the number of rolls that can be stored is not limited to one. Two or three or more rolls may be stored, and the sheet S may be selectively pulled out and supplied from among the plurality of rolls.

The first dancer unit 3 is a unit for applying a constant sheet tension between the unwinding roll unit 2 and the first main conveyance unit 4. In the first dancer unit 3, the sheet tension is applied by a tension application unit (not shown).

The first main conveyance unit 4 is a unit for feeding the sheet S to the subsequent unit and for applying a predetermined tension to the sheet in cooperation with the second main conveyance unit 14. The first main conveyance unit 4 rotates by driving a motor (not shown) and conveys the sheet S while applying tension to the sheet S.

The meandering correction unit 5 is a unit for correcting meandering in the sheet width direction during conveyance of the sheet S under tension. The meandering correction unit 5 includes a meandering correction roller 5a and a meandering detection sensor (not shown) configured to detect meandering of the sheet S. The meandering correction roller 5a can change the inclination of the sheet S by a motor (not shown), and corrects the meandering of the sheet S based on the measurement result from the meandering detection sensor. In this case, the meandering correction function can be improved by wrapping the sheet S around the meandering correction roller 5a. The meandering correction unit 5 can set the conveyance direction of the meandering sheet S back to the normal conveyance direction.

The conveyance detection unit 6 is a unit for detecting the tension during the conveyance of the sheet under tension between the first main conveyance unit 4 and the second main conveyance unit 14. The conveyance detection unit 6 is also a unit for detecting the speed of the sheet S to control the printing timing of the printing unit 8.

The mark sensor unit 7 is a unit for detecting marks printed on the sheet S in advance to control the printing timing of the printing unit 8.

The printing unit 8 is a unit for printing on the conveyed sheet S, and prints an image by performing printing processing (specifically, ink ejection and the like) on the sheet S from above using the printing head 22. The conveyance path in the printing unit 8 is formed by a plurality of guide rollers 23 arranged in an upward convex circular arc configuration, and a certain tension is applied to the sheet S to ensure a clearance between the sheet S and the printing head 22. A plurality of the printing heads 22 are arranged along the conveyance direction. The printing apparatus 1 of this example includes a total of eight line-type printing heads corresponding to a reaction liquid and three particular colors, in addition to four colors, black (Bk), yellow (Y), magenta (M), and cyan (C). The number of colors is not limited to four, and the number of printing heads is not limited to eight. The inkjet method applied to the printing head 22 may be a method using a heating element, a method using a piezoelectric element, a method using an electrostatic element, a method using a MEMS element, or the like. Each color of ink is supplied to the printing head 22 from a corresponding ink tank (not shown) through an ink tube.

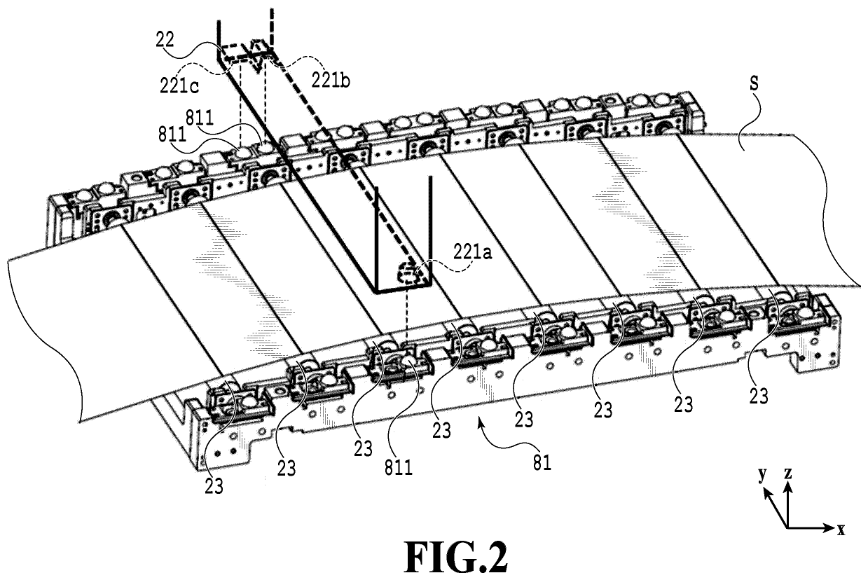

FIG. 2 is a perspective view of a sheet conveyance unit housing in the printing unit 8. As shown in FIG. 2, a sheet conveyance unit housing 81 of the printing unit 8 is provided with a plurality of printing head positioning members 811 for positioning the printing head 22. More specifically, three printing head positioning members 811 are provided for each printing head 22. These three printing head positioning members 811 are provided at different positions in the y direction, one on the front side (−y side) and two on the back side (+y side) in FIG. 2, so as to sandwich the sheet S.

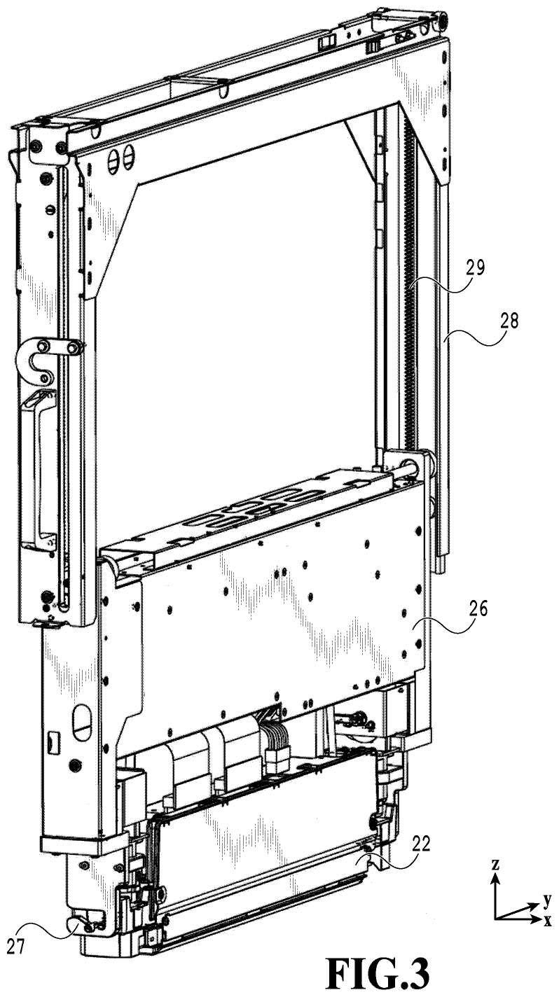

FIG. 3 is a perspective view showing a elevating and lowering mechanism of the printing head 22. As shown in FIG. 3, the printing head 22 is supported by a printing head holding unit 26 configured to hold and elevate and lower the printing head 22, with a printing head supporting shaft 27 supported from below. The printing head holding unit 26 performs a elevating and lowering operation along a printing head elevating and lowering rail 29 provided in a printing head elevating and lowering frame 28 by a drive mechanism (not shown) provided therein.

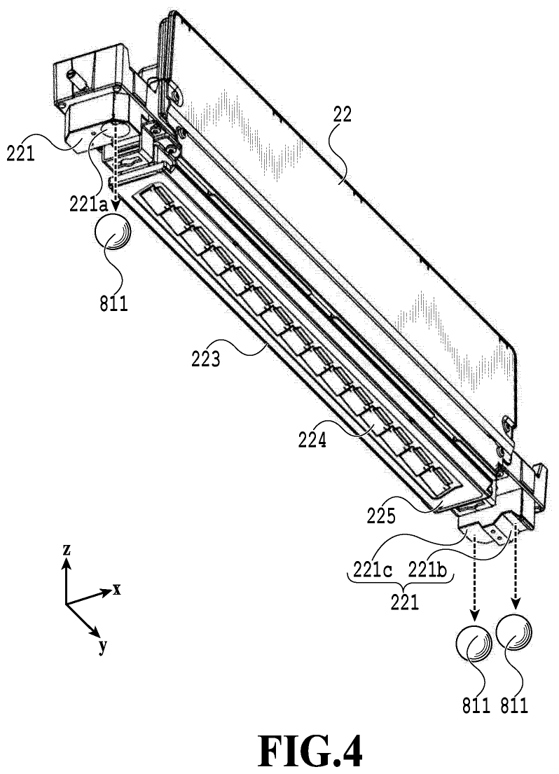

FIG. 4 is a perspective view of the printing head 22, showing a nozzle formation surface 223. The nozzle formation surface 223 facing the sheet is provided with a plurality of nozzle plates 224. The plurality of nozzle plates 224 are each provided with a plurality of nozzles for ejecting ink droplets onto the sheet S.

Here, the components in FIG. 1 will be described with reference again to FIG. 1. The first scanner unit 9 is a unit for reading an image printed on the sheet S by the printing unit 8 and detecting the misalignment and density of the image. The detection result from the first scanner unit 9 is used for correction, for example, position correction and color correction.

The first drying unit 10 and the second drying unit 11 are units for improving fixing of the ink to the sheet S by reducing the liquid content in the ink applied to the sheet S by the printing unit 8. The second drying unit 11 is disposed on the downstream side of the first drying unit 10 in the sheet conveyance direction. The first drying unit 10 and the second drying unit 11 dry the applied ink by heating the printed sheet S. Inside the first drying unit 10 and the second drying unit 11, hot air is applied to the passing sheet S at least from the ink application surface side, thereby drying the ink application surface. As for a drying method, besides the method of applying hot air, a method of irradiating the sheet S surface with electromagnetic waves (ultraviolet rays, infrared rays or the like) or a conductive heat transfer method using contact with a heating element may be adopted in combination.

A winding guide roller 31 is a roller configured to wind the surface of the sheet S opposite to the ink application surface at a constant winding angle on the downstream side of the printing unit 8 in the conveyance direction for the purpose of blocking the effect of hot air generated by the first drying unit 10 on the printing unit 8. In this example, two winding guide rollers 31 are disposed between the first scanner unit 9 and the first drying unit 10, and the sheet S is folded back so as to be substantially parallel above and below the apparatus. The first drying unit 10 is disposed below the printing unit 8, and the second drying unit 11 is disposed below the conveyance detection unit 6 and the mark sensor unit 7.

The cooling unit 12 cools the sheet S with the ink fixed thereon by the first drying unit 10 and the second drying unit 11, solidifies the softened ink, and suppresses changes in temperature of the sheet S throughout the processing by each unit on the downstream side in the conveyance direction of the printing apparatus 1. Inside the cooling unit 12, air at a temperature lower than that of the sheet S is applied to the passing sheet S at least from the ink application surface side, thereby cooling the ink application surface of the sheet S. The cooling method is not limited to the method of applying air, but may be a conductive heat transfer method using contact with a heat-dissipating member, or a combination of these methods.

The second scanner unit 13 is a unit for reading a test image printed on the sheet S by the printing unit 8 before actual printing, and detecting the misalignment and density of the image. The detection result from the second scanner unit 13 is used for correction in the actual printing after the test image is printed.

The second main conveyance unit 14 is a unit configured to function by operating together with the first main conveyance unit 4, and is a unit for conveying the sheet S while applying tension to the sheet S and adjusting the tension of the sheet S. The second main conveyance unit 14 is driven by a motor (not shown) to rotate. The tension of the sheet S is adjusted by a clutch (not shown) capable of controlling the driven and connected torque based on the tension value detected by a tension control unit (not shown). Note that, as an additional configuration for adjusting the tension of the sheet S, a configuration may be added to control the speed of the second main conveyance unit 14 based on the detection result from the conveyance detection unit 6. As a method for realizing this configuration, it is conceivable to use either a torque control method for controlling the value of the torque transmitted from the clutch, or a speed control method for controlling the roller speed of the second main conveyance unit 14. Alternatively, these two methods may be used in a switched manner depending on the purpose, or both may be used simultaneously.

The second dancer unit 15 is a unit for applying a constant tension between the second main conveyance unit 14 and the winding roll unit 16. In the second dancer unit 15, a constant tension is applied to the sheet by a tension application unit (not shown).

The winding roll unit 16 is a unit for winding the printed sheet S onto a winding core. Although one roll can be collected in FIG. 1, the number of rolls that can be collected is not limited to one. Two or three or more winding cores may be provided and selectively switched to collect the sheet S. Depending on the details of treatment after printing, the continuous sheet may be cut using a cutter, and the cut sheet S may be stacked, instead of winding the sheet S onto the winding core.

The control unit 21 is a unit configured to control the respective units in the printing apparatus 1. The control unit 21 includes a CPU, a storage unit, a controller including various control units, an external interface, and an operation unit 24 for a user to perform input and output. The operation of the printing apparatus 1 is controlled based on commands inputted through the operation unit 24 or commands from a host apparatus 25 such as a host computer connected to the controller through the external interface.

The maintenance tray 17 is a maintenance mechanism including a member configured to recover the ejection performance of the printing head 22. Examples of the member configured to recover the ejection performance include a cap member configured to protect the nozzle formation surface 223 of the printing head 22, a wiper member configured to wipe the nozzle formation surface 223, a suction member configured to suck the ink in the printing head 22 by negative pressure from the nozzle formation surface 223, and the like.

### <Configuration of Maintenance Tray>

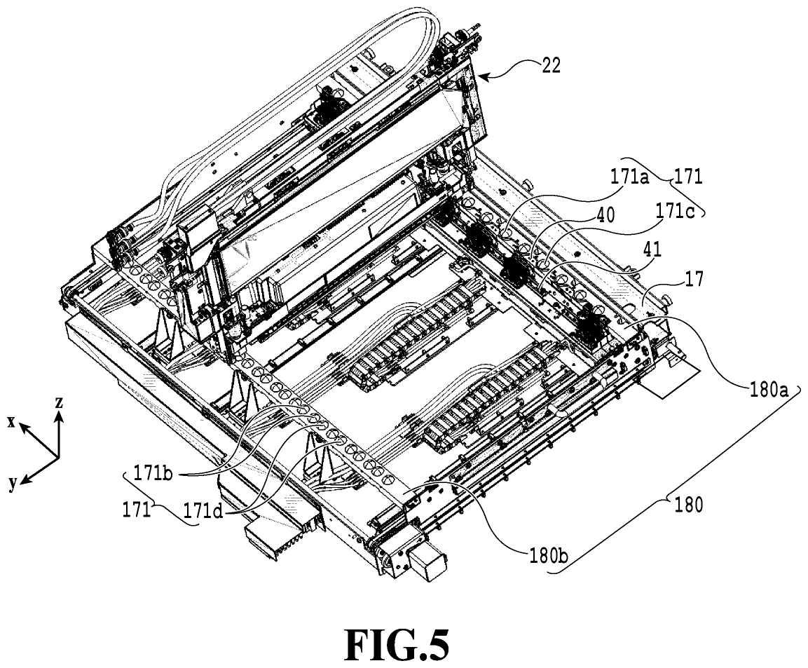

FIG. 5 is a perspective view of the maintenance tray 17 and the printing head positioned on the maintenance tray. Here, one printing head 22 is illustrated. As shown in FIG. 5, the maintenance tray 17 is provided with a first maintenance unit 40 corresponding to each printing head 22. The maintenance tray 17 is provided with a second maintenance unit 41 corresponding to each printing head 22, in addition to the first maintenance unit 40. The maintenance tray 17 according to this embodiment is configured to be able to also perform maintenance using the second maintenance unit 41, in addition to maintenance using the first maintenance unit 40. The first maintenance unit 40 and the second maintenance unit 41 will be described in detail later. It is required to provide the second maintenance unit 41 configured to perform additional maintenance without increasing the size of the maintenance tray 17.

In this embodiment, in the maintenance tray 17, one first maintenance unit 40 and one second maintenance unit 41 are provided corresponding to one printing head 22. The first maintenance unit 40 and the second maintenance unit 41 are disposed side by side in the x direction, which is the head transverse direction of the printing head 22. The maintenance tray 17 is also provided with a plurality of spherical printing head positioning members 171 for positioning the printing head 22 with respect to each maintenance unit. The plurality of printing head positioning members 171 corresponding to a certain printing head 22 are arranged in the maintenance tray 17 so as to be positioned at front and back in the apparatus depth direction (y direction), and are held by a beam member 180 extending along the sheet conveyance direction (x direction). Of two beam members 180, the beam member on the −y direction side is referred to as a front beam 180a and the beam member on the +y direction side is referred to as a back beam 180b. In this example, three balls of the printing head positioning members 171 are required to position one printing head 22 with respect to the maintenance tray 17. Specifically, the first maintenance unit 40 has one printing head positioning member (171a in FIG. 5) disposed on the front beam 180a and two printing head positioning members (171b in FIG. 5) disposed on the back beam 180b in the maintenance tray 17. Similarly, the second maintenance unit 41 has one printing head positioning member (171c in FIG. 5) disposed on the front beam 180a and two printing head positioning members (171d in FIG. 5) disposed on the back beam 180b.

The ball arrangement used for positioning is not limited to the above. A configuration may be adopted, including two balls on the front side and one on the rear side. Alternatively, a configuration may be adopted, in which one ball is disposed on the front side and one on the rear side, and the posture of the printing head 22 is determined at a different location. The positioning configuration is also not limited to the configuration using the spherical positioning member. For example, a configuration may be adopted in which a part of the printing head 22 abuts against the inside of the maintenance tray 17. Alternatively, a configuration may be adopted in which positioning is performed using holes and pins provided in the maintenance tray 17 and the printing head 22.

The position where the printing head 22 is positioned by the printing head positioning members 171a and 171b of the maintenance tray 17 is referred to as a first cleaning position. The position where the printing head 22 is positioned by the printing head positioning members 171c and 171d of the maintenance tray 17 is referred to as a second cleaning position.

### <Positioning of Printing Head Relative to Maintenance Tray>

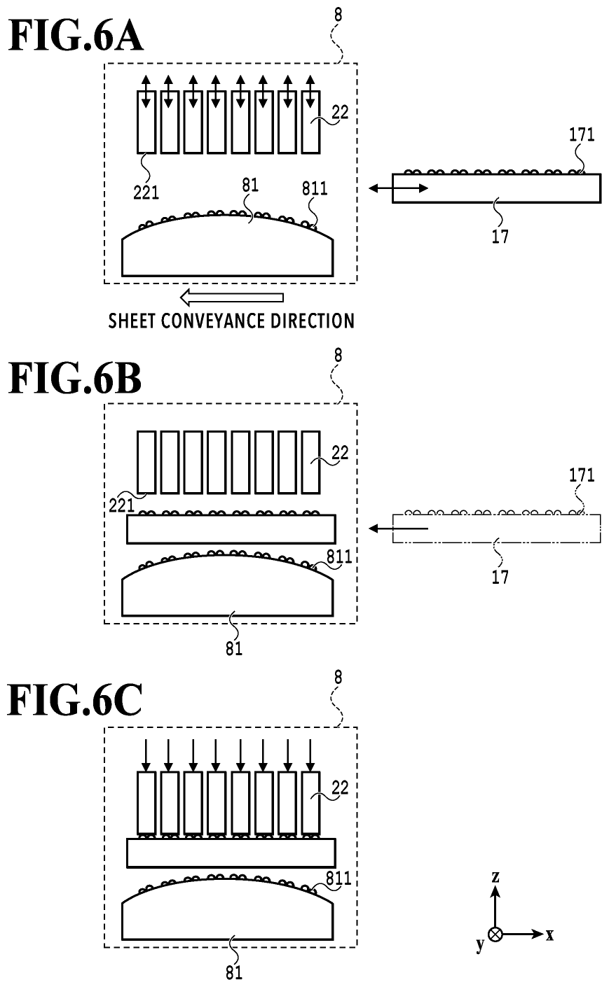

FIGS. 6A to 6C are schematic diagrams showing an operation of positioning the printing head 22 relative to the maintenance tray 17. During a printing operation, the maintenance tray 17 is retracted to the sheet feed side of the printing apparatus 1 relative to the printing unit 8.

In a case of performing a maintenance operation for the printing head 22, the printing head 22 is moved to above the sheet conveyance unit housing 81 by the elevating and lowering mechanism of the printing head described above. The maintenance tray 17 moves to a position retracted from the printing head 22 (shown in FIG. 6A and referred to as a retracted position). Thereafter, as shown in FIG. 6B, the maintenance tray 17 moves horizontally from the retracted position to below the printing head 22 by a drive mechanism and rails (not shown). The maintenance tray 17 is provided with the printing head positioning members 171, and a positioning member 221 for the printing head 22 is provided at the lower side of the printing head 22. The printing head 22 is lowered to be positioned relative to the maintenance tray 17 as shown in FIG. 6C. FIGS. 6B and 6C show a state where the maintenance tray 17 is located at the first cleaning position. The position where the maintenance tray 17 is shifted in the x direction (horizontal direction) from the position in FIGS. 6B and 6C is the second cleaning position. The second cleaning position is the position where the printing head positioning members 171c and 171d of the maintenance tray 17 are located at positions corresponding to the positioning member 221 of the printing head 22.

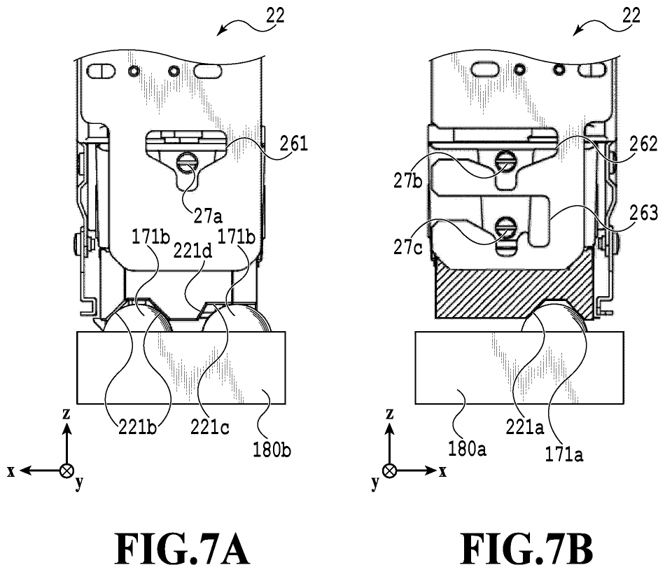

FIGS. 7A and 7B show a state upon completion of the positioning of the printing head 22 on the maintenance tray 17. FIG. 7A is a view from the back side of the apparatus. FIG. 7B is a view from the front side of the apparatus. As shown in FIG. 7, the positioning member 221 includes a conical recess 221a, a V-shaped groove 221b, and a flat surface 221c.

As shown in FIGS. 7A and 7B, as the printing head holding unit 26 is lowered, the positioning member 221 of the printing head 22 abuts against the printing head positioning member 171 of the maintenance tray 17. As the printing head holding unit 26 is further lowered, a first pin 27a of the printing head 22 is separated from a first hole 261 of the printing head holding unit 26, a second pin 27b is separated from a second hole 262, and a third pin 27c is separated from a third hole 263. In this event, the positioning member 221 of the printing head 22 is equalized by the printing head positioning member 171, and the printing head 22 is positioned with high accuracy relative to the maintenance tray 17.

In the case where the positioning member 221 abuts against the printing head positioning members 171a and 171b, as shown in FIGS. 6A, 6B, 7A, and 7B, the printing head 22 is set in a cleaning position corresponding to the first maintenance unit 40. Specifically, the printing head positioning members 171a and 171b are members for positioning the printing head 22 at the first cleaning position of the maintenance tray 17. Although not shown in FIGS. 7A and 7B, in a case where the positioning member 221 abuts against the printing head positioning members 171c and 171d, the printing head 22 is set in a cleaning position corresponding to the second maintenance unit 41. Specifically, the printing head positioning members 171c and 171d are members for positioning the printing head 22 at the second cleaning position of the maintenance tray 17.

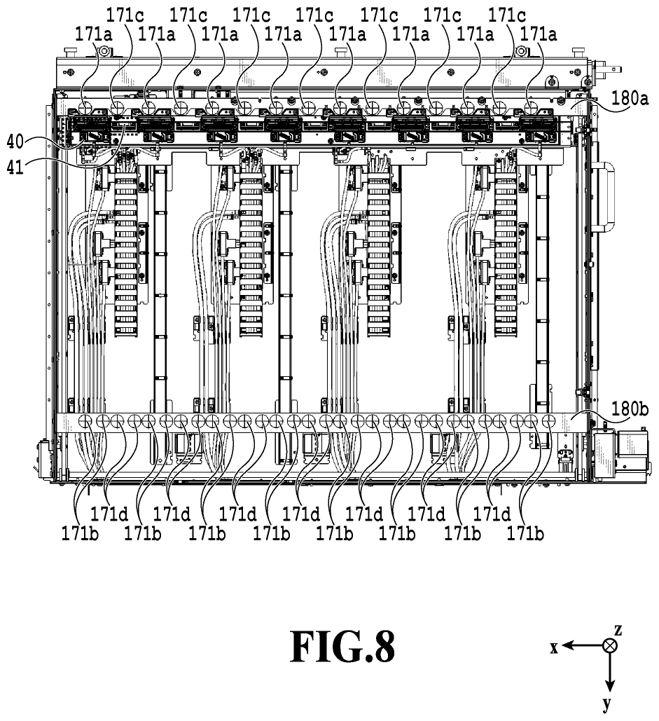

FIG. 8 is a top view of the maintenance tray. FIG. 8 shows the arrangement of each maintenance unit and the printing head positioning member corresponding thereto. On the front beam 180a, the printing head positioning members 171a for the first maintenance unit 40 and the printing head positioning members 171c for the second maintenance unit 41 are arranged alternately, one by one, in the head transverse direction (x direction). The printing head positioning members are also arranged on the back beam 180b facing the front beam 180a. On the back beam 180b, the printing head positioning members 171b for the first maintenance unit 40 and the printing head positioning members 171d for the second maintenance unit 41 are arranged alternately, two by two, in the head transverse direction (x direction). The two printing head positioning members 171b are arranged at positions corresponding to the printing head positioning members 171a. The two printing head positioning members 171d are arranged at positions corresponding to the printing head positioning members 171c. In a standby state where no maintenance is performed, the first maintenance unit 40 and the second maintenance unit 41 are located at a position on the front beam 180a side (hereinafter referred to as the standby position) as shown in FIG. 8. The standby position of each maintenance unit is a position closer to the front beam 180a between the printing head positioning members (for example, 171a and 171b) facing each other in the y direction.

The back beam 180b in FIG. 8 is configured to have two printing head positioning members provided for one printing head. Specifically, with limited space in the x direction, two printing head positioning members need to be provided for each maintenance unit. In this embodiment, a gap in the x direction between a slope surface 221d (FIG. 7A) of the positioning member 221c of the printing head 22 and the printing head positioning member 171 is used. By using this gap, the positions of the head positioning members of each maintenance unit are adjusted so that they are not too close to each other in the x direction. This will be described in detail below.

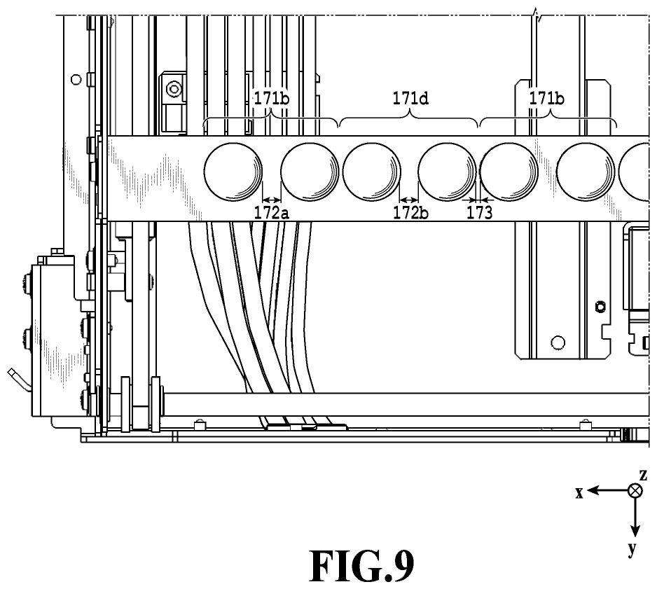

FIG. 9 is a diagram showing a pitch between the printing head positioning members 171 on the back beam 180b. As described above, two printing head positioning members 171 are provided on the back beam 180b so as to correspond to each maintenance unit. FIG. 9 shows a pitch 172a between the printing head positioning members 171b for the first maintenance unit 40. FIG. 9 also shows a pitch 172b between the printing head positioning members 171d for the second maintenance unit 41.

Here, on the page space of FIG. 9, the member on the −x direction side of the two printing head positioning members is simply referred to as the right ball, and the member on the +x direction side thereof is referred to as the left ball. It is assumed that the printing head positioning members 171d for the second maintenance unit are to be arranged at the same pitch 172a as the printing head positioning members 171b for the first maintenance unit. In this case, a gap 173 between the right ball of the printing head positioning members 171d and the left ball of the printing head positioning members 171b becomes small, making the balls too close to each other. If the balls are too close to each other, there is a possibility that the printing head 22 may interfere with the adjacent first maintenance unit 40 during maintenance of the printing head 22 using the second maintenance unit 41. On the other hand, the interference of the printing head 22 can be avoided by setting the pitch 172b to be the same as the pitch 172a while maintaining the size of the gap 173 at a predetermined size. However, the size of the maintenance tray 17 in the x direction becomes large.

As described in FIGS. 7A and 7B, the printing head 22 is positioned by the three printing head positioning members 171. As shown in FIG. 7B, the printing head positioning member 171a (171c) on the front side abuts against the positioning member 221a of the printing head 22 at two locations on the slope surface. As shown in FIG. 7A, the left ball of the printing head positioning members 171b (171d) on the back side (end side) similarly abuts against the positioning member 221b of the printing head 22 at two locations on the slope surface. On the other hand, the right ball of the printing head positioning members 171b (171d) on the back side abuts against the positioning member 221c of the printing head 22 at one location on the horizontal surface. The right ball is used to regulate the rotation of the printing head 22 by abutting on the horizontal surface. Since the right ball thus abuts against the positioning member 221c of the printing head 22 at one location, the arrangement position can be adjusted, although only slightly, in the x direction. As shown in FIG. 7A, a gap is formed between the right ball and the slope surface 221d of the positioning member 221c of the printing head 22. Therefore, in this gap portion, there is no problem in adjusting the arrangement position in the x direction.

In this embodiment, the positioning member 221c of the printing head 22 contacts the printing head positioning members 171b (171d) only in the flat portion. This reduces the gap in the x direction between the slope surface 221d and the printing head positioning member 171, thus adjusting the pitch 172b. Specifically, the members are arranged such that the pitch 172b is smaller than the pitch 172a. This ensures the gap 173 between the right ball of the printing head positioning members 171d and the left ball of the printing head positioning members 171b. This makes it possible to prevent the printing head 22 from interfering with other maintenance units during maintenance. Although, in this embodiment, the description is given of the arrangement example where the pitch 172b is smaller than the pitch 172a, it is also possible to arrange the members such that the pitch 172a is smaller than the pitch 172b.

The arrangement of the printing head positioning members 171 has been described above. The maintenance units are also arranged alternately in the head transverse direction on the maintenance tray 17, in accordance with the arrangement of the printing head positioning members 171.

In this embodiment, the maintenance tray 17 is provided with the second maintenance unit 41 in addition to the first maintenance unit 40. As described later, the first maintenance unit 40 applies a cleaning liquid to ink sticking to the nozzle formation surface 223 and having increased adhesion, thereby suppressing the adhesion, and then removes the ink and the cleaning liquid with a blade. In addition, negative pressure is applied to the nozzle formation surface 223 to remove the sticking ink that cannot be cleaned by wiping with the blade alone. There is a possibility, however, that the remaining ink or cleaning liquid cannot be completely removed with such a cleaning operation. For this reason, in this embodiment, the second maintenance unit 41 with high removal power is additionally provided. As described later, in the maintenance unit, a mechanism for performing maintenance is elevated so as to act on the nozzle formation surface 223 of the printing head 22 during a maintenance operation. The maintenance unit, together with the mechanism itself that performs such a elevating and lowering operation, is configured to scan in the longitudinal direction of the printing head 22. If the second maintenance unit 41 is added in the longitudinal direction (y direction) of the printing head 22, for example, if the second maintenance unit 41 is added at a position adjacent to the first maintenance unit 40 in the y direction, the maintenance tray 17 is increased in size. More specifically, the second maintenance unit 41, which is additionally provided in the y direction, also has the standby position of the maintenance unit extended in the y direction so as to act on the nozzle formation surface 223. This also increases the size of the maintenance tray 17 in the y direction. As a result, the printing apparatus 1 is increased in size.

In this embodiment, as described above, the first maintenance unit 40 and the second maintenance unit 41 are alternately arranged in the head transverse direction. This makes it possible to prevent an increase in space of the maintenance tray 17 in the y direction in FIG. 8, compared to the case where the maintenance units are arranged in the head longitudinal direction.

### <Configuration Example of Maintenance Unit>

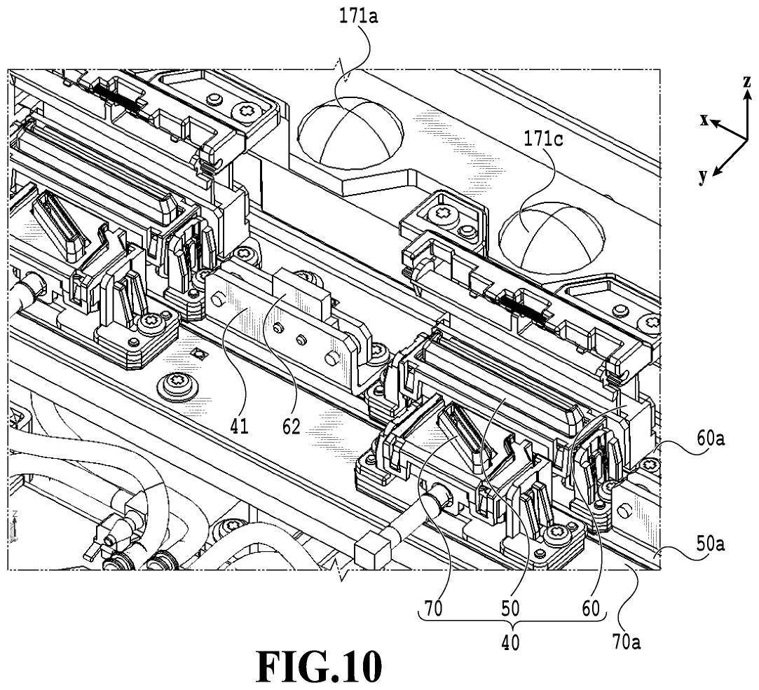

FIG. 10 is a perspective view showing the configuration of the maintenance unit. The first maintenance unit 40 includes a cleaning liquid application unit 50, a first wiper unit 60, and a suction unit 70. The cleaning liquid application unit 50 is a mechanism for applying a cleaning liquid to the nozzle formation surface 223 of the printing head 22. The first wiper unit 60 is a mechanism for removing ink, paper dust, or the cleaning liquid adhering to the printing head 22. The first wiper unit 60 is, for example, a wiper blade. The suction unit 70 is a mechanism for applying negative pressure to the nozzle plate 224 of the printing head 22 to remove ink sticking to the nozzle formation surface 223 or remove bubbles in an ink flow path. The second maintenance unit 41 includes a second wiper unit 62 having a blade of a different shape or material from that of the first wiper unit 60. As shown in FIG. 10, the first maintenance unit 40 and the second maintenance unit 41 are disposed side by side in the head transverse direction (x direction). More specifically, the second wiper unit 62 of the second maintenance unit 41 is disposed in line with the cleaning liquid application unit 50 in the head transverse direction (x direction).

More specifically, each mechanism is provided on a stage that can be elevated and lowered. Specifically, the cleaning liquid application unit 50 is provided on a first stage 50a. The first wiper unit 60 is provided on a second stage 60a. The suction unit 70 is provided on a third stage 70a. The second wiper unit 62 is also provided on the first stage 50a, as with the cleaning liquid application unit 50. The maintenance unit performs maintenance using the corresponding mechanism while moving in the scanning direction. In this embodiment, the first stage 50a, the second stage 60a, and the third stage 70a are configured to be driven by the same driving source. Therefore, upon execution of maintenance by any of the mechanisms of the maintenance unit, the first stage 50a, the second stage 60a, and the third stage 70a move together in the scanning direction. In this embodiment, each maintenance unit is provided corresponding to each printing head. Therefore, upon execution of maintenance, the respective maintenance units move together in the scanning direction.

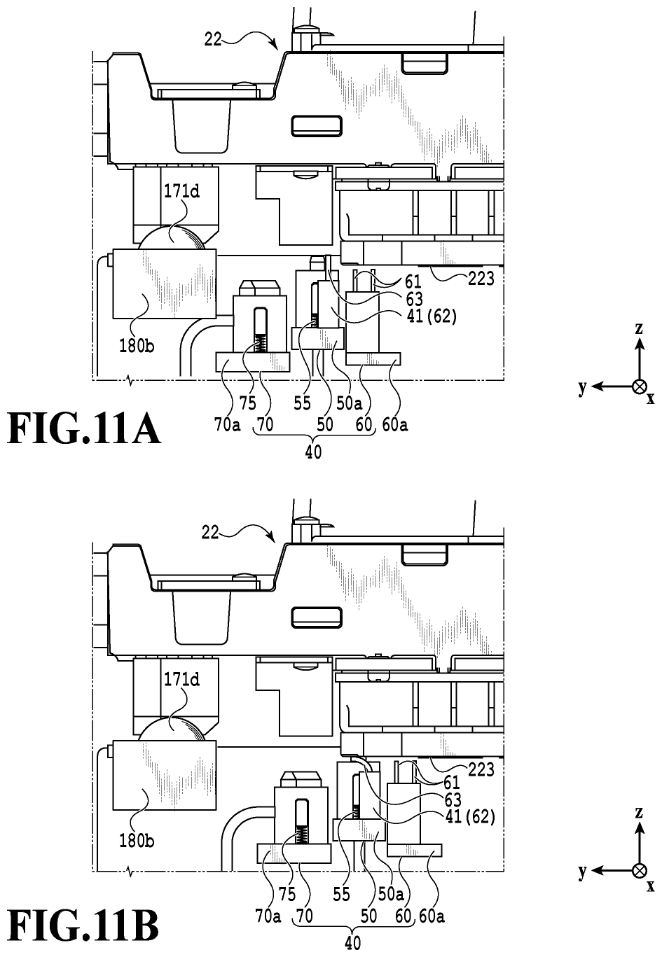

FIGS. 11A and 11B are cross-sectional side views of a part of the maintenance tray 17. In FIGS. 11A and 11B, the printing head 22 is positioned in the maintenance tray 17. FIGS. 11A and 11B show a state where the printing head 22 is cleaned by the second maintenance unit 41 in the maintenance tray 17. That is, FIGS. 11A and 11B show a state where the maintenance tray 17 is located at the second cleaning position and the printing head 22 is positioned in the maintenance tray 17. The second maintenance unit 41 of this embodiment performs maintenance while scanning in the +y direction from the standby position on the front beam 180a. Then, after scanning to the back beam 180b side, the second maintenance unit 41 performs maintenance while scanning in the −y direction. In other words, the second maintenance unit 41 is configured to perform maintenance while scanning in both forward direction and backward direction. FIG. 11A is a diagram upon completion of scanning in the forward direction (−y direction). FIG. 11B is a diagram at the start of scanning in the backward direction (+y direction). As shown in FIGS. 11A and 11B, removability is ensured by a bending direction of the second wiper unit 62 (blade), which abuts against the nozzle formation surface 223 of the printing head 22, being opposite to the traveling direction of the second maintenance unit 41. While FIGS. 11A and 11B show the maintenance in the backward direction, the removability is also ensured in the forward direction by the bending direction of the second wiper unit 62 (blade), which abuts against the nozzle formation surface 223 of the printing head 22, being opposite to the traveling direction of the second maintenance unit 41. The second maintenance unit 41 is used in a case where the first maintenance unit 40 cannot completely remove the soiling on the nozzle formation surface 223.

As described above, the second maintenance unit 41 (second wiper unit 62) is provided on the same first stage 50a as the cleaning liquid application unit 50 in the first maintenance unit 40. Therefore, the first stage 50a is elevated as the second maintenance unit 41 acts on the nozzle formation surface 223. As shown in FIGS. 11A and 11B, since the first stage 50a is elevated, the cleaning liquid application unit 50 is also elevated, in addition to the second maintenance unit 41. In the example of FIGS. 11A and 11B, the printing head 22 is positioned by the printing head positioning member 171d and the printing head positioning member 171c (not shown). That is, in the example of FIGS. 11A and 11B, the maintenance tray 17 is located at the second cleaning position. Therefore, the nozzle formation surface 223 is not located on the scanning of the cleaning liquid application unit 50, but is located on the scanning of the second maintenance unit 41. Therefore, even if the first stage 50a is elevated and scanned in the head longitudinal direction together with the second stage 60a and the third stage 70a, the nozzle formation surface 223 can be prevented from colliding with the adjacent first maintenance unit 40.

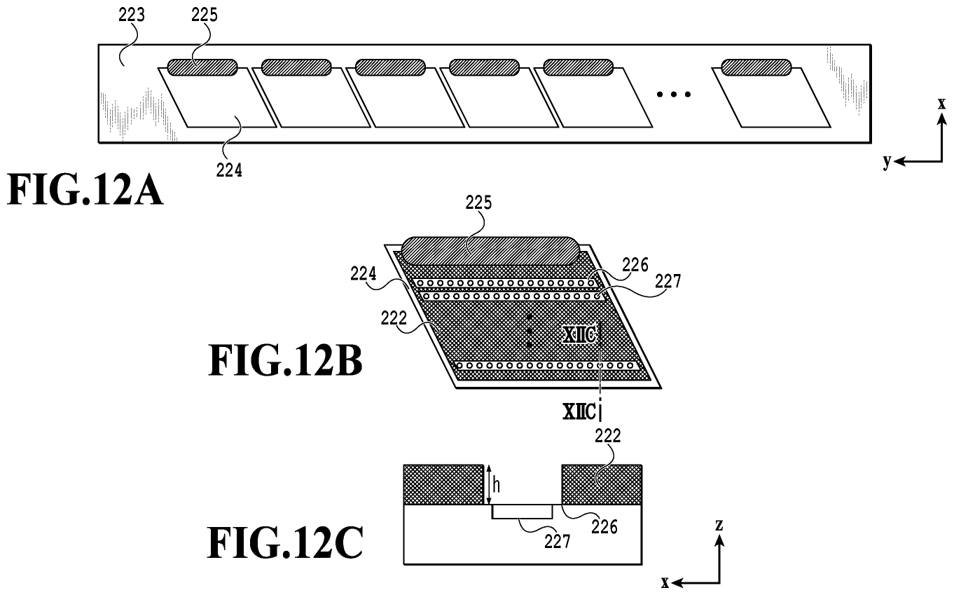

FIGS. 12A to 12C are diagrams explaining the configuration of the nozzle formation surface, which is the surface subjected to head cleaning. FIG. 12A is a schematic plan view of the nozzle formation surface 223. As shown in FIG. 12A, a plurality of nozzle plates 224 are arranged along the head longitudinal direction (y direction) on the nozzle formation surface 223. Each nozzle plate 224 has an electrical connection part (not shown) for electrical connection. The electrical connection part is covered with a sealing portion 225 made of a resin material or the like, and protected from corrosion or disconnection. FIG. 12B is a diagram showing one structure of the nozzle plate 224. The nozzle plate 224 has an ejection port array 226 in which a plurality of ejection ports 227 are arranged. The nozzle plate 224 is also provided with an ejection energy generating element (not shown) corresponding to each ejection port 227. The periphery of the ejection port array 226 is covered with a nozzle guard 222 for protecting the nozzles. FIG. 12C is a cross-sectional view taken along line XIIc-XIIc in FIG. 12B. A height difference h between the nozzle guard 222 and the nozzle port array 226 is 30 μm in this embodiment, but is not limited to this value.

The difference between the first wiper unit 60 and the second wiper unit 62 will be described below with reference to FIGS. 10 to 11B. The first wiper unit 60 is a mechanism for removing ink, paper dust, cleaning liquid or the like adhering to the nozzle guard 222, which is a convex part of the nozzle formation surface 223, by wiping the nozzle formation surface 223 while applying contact force thereto using a first blade 61. The width (x direction) of the first blade 61 is set to be equal to or greater than the x-direction length of the nozzle formation surface 223, since it is necessary to wipe the entire surface of the nozzle formation surface 223. The second wiper unit 62 is a mechanism for removing ink sticking to the nozzle port array 226, which is a concave part of the nozzle formation surface 223, that cannot be completely removed by the suction unit 70, by wiping the nozzle formation surface 223 while applying contact force thereto using a second blade 63. The width (x direction) of the second blade 63 may be equal to or greater than the x-direction length of the nozzle formation surface 223 where the ejection port array 226 is present. In this embodiment, the width of the second blade 63 is set to be shorter than the width of the first blade 61. Note that an example is shown in this embodiment where there are two first blades 61 and one second blade 63, but the present disclosure is not limited thereto. The first blade 61 and the second blade 63 may each be one or more than one.

The wiping by the first wiper unit 60 requires a certain contact force or more on the nozzle guard 222 to clean the nozzle guard 222. On the other hand, the wiping by the first wiper unit 60 requires a contact force of less than or equal to a certain pressure on the nozzle port array 226 to suppress damage to the nozzles 227. The wiping by the second wiper unit 62 requires a certain contact force or more to be applied to the nozzle port array 226, which is the concave part of the nozzle formation surface 223. On the other hand, the wiping by the second wiper unit 62 is required to suppress damage to the members (sealing unit 225 and the like) on the convex part of the nozzle formation surface 223 due to excessive contact force on the convex part, and also to suppress damage to the second wiper unit 62 itself.

Therefore, in this embodiment, both cleaning performance and durability of the convex and concave parts are achieved by adopting elastic materials suitable for the respective applications of the first wiper unit 60 and the second wiper unit 62.

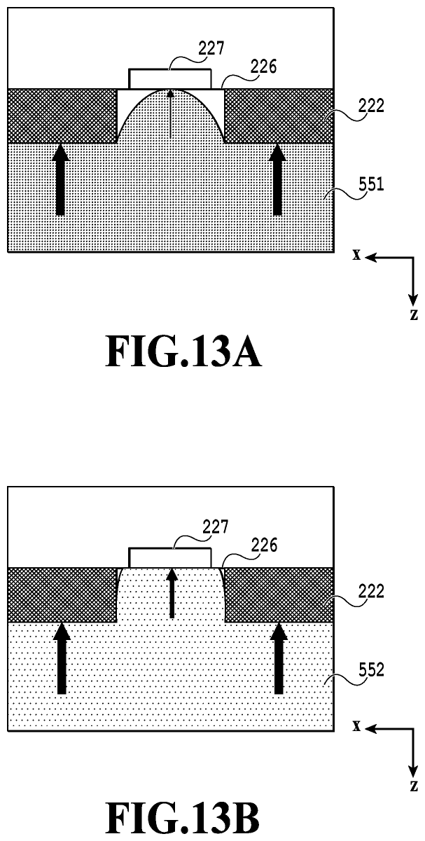

FIGS. 13A and 13B are cross-sectional views taken along line XIIc-XIIc in FIG. 12B, schematically showing a state upon contact with a blade member. Note that FIGS. 13A and 13B are vertically inverted from FIG. 12C. FIG. 13A is an image diagram upon contact with a blade member with a relatively high hardness on the cross section taken along line XIIc-XIIc in FIG. 12B. FIG. 13B is an image diagram upon contact with a blade member with a relatively low hardness on the cross section taken along line XIIc-XIIc in FIG. 12B. The adaptability to the step is poor in a case of wiping using an elastic material 551 with high hardness, but is good in a case of using an elastic material 552 with low hardness. In other words, the use of the blade member with high hardness makes it possible to apply a large contact force to the convex part of the nozzle formation surface 223 while suppressing the contact force to the concave part thereof. On the other hand, the use of the blade member with low hardness makes it possible to apply a necessary contact force to the concave part of the nozzle formation surface 223 while suppressing the contact force on the convex part thereof. However, for scanning while applying a contact force to the nozzle formation surface 223, it is preferable that the first wiper unit 60 and the second wiper unit 62 have a minimum hardness or more that allows designing of the contact force, and that each blade member has a hardness less than or equal to the upper limit of the hardness that allows deformation of the blade member. Specifically, the hardness is preferably more than or equal to 10 Hs and less than or equal to 90 Hs.

Although several types of cleaning mechanisms have been described above as the examples of the mechanisms included in the maintenance unit, the types of cleaning mechanisms are not limited to the examples described for both the first maintenance unit 40 and the second maintenance unit 41. For example, other cleaning mechanisms may be provided in the maintenance unit, such as a configuration for cleaning the nozzle formation surface 223 by making a web abut thereagainst, or a configuration in which a porous body abuts against the nozzle formation surface 223.

### <Elevating and Lowering of Maintenance Unit>

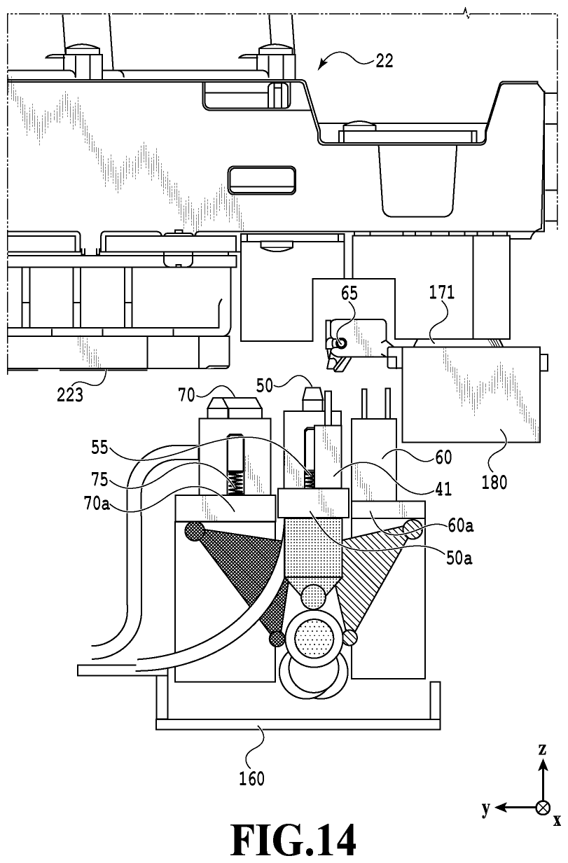

FIG. 14 is a diagram showing a state where the printing head 22 is positioned on the printing head positioning member 171 held by the beam member 180. FIG. 14 shows a state where the cleaning liquid application unit 50, the first wiper unit 60, the second wiper unit 62, and the suction unit 70 are retracted in the −z direction relative to the height of the nozzle formation surface 223. In a case where any of the cleaning liquid application unit 50, the first wiper unit 60, the second wiper unit 62, and the suction unit 70 acts on the nozzle formation surface 223, the cleaning mechanism to be brought into contact with the nozzle formation surface 223 needs to be moved to the contact position with the nozzle formation surface 223. The position (contact position) where the cleaning mechanism acts on the nozzle formation surface 223 is referred to as a first position. The position where the cleaning mechanism stands by is referred to as a second position. Specifically, the cleaning mechanism is elevated from the second position in the height direction and moved to the first position, and then moved in the scanning direction to perform scanning. As described above, the cleaning liquid application unit 50 and the second wiper unit 62 are provided on the first stage 50a. The first wiper unit 60 is provided on the second stage 60a. The suction unit 70 is provided on the third stage 70a. In this embodiment, each cleaning mechanism is configured to be elevated and lowered as each stage is elevated and lowered. FIG. 14 shows an example where a blade cleaner 65 is also provided to remove liquid, paper dust or the like adhering to the first wiper unit 60 and recover the removability of the first wiper unit 60. A support member 160 supports each stage.

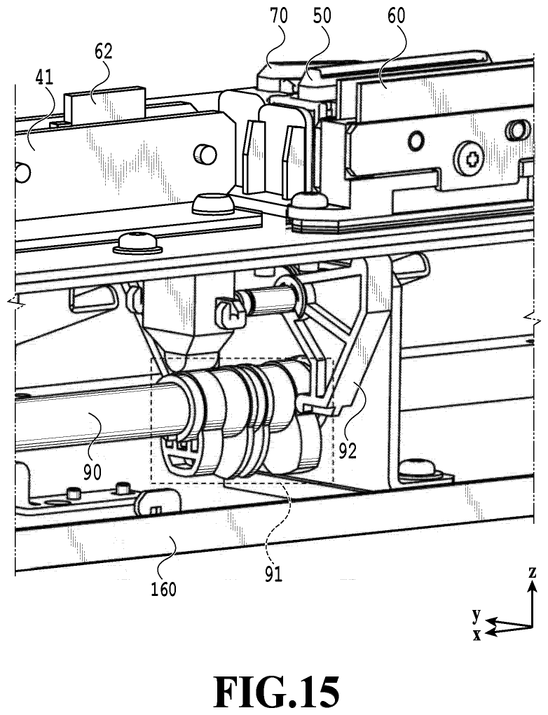

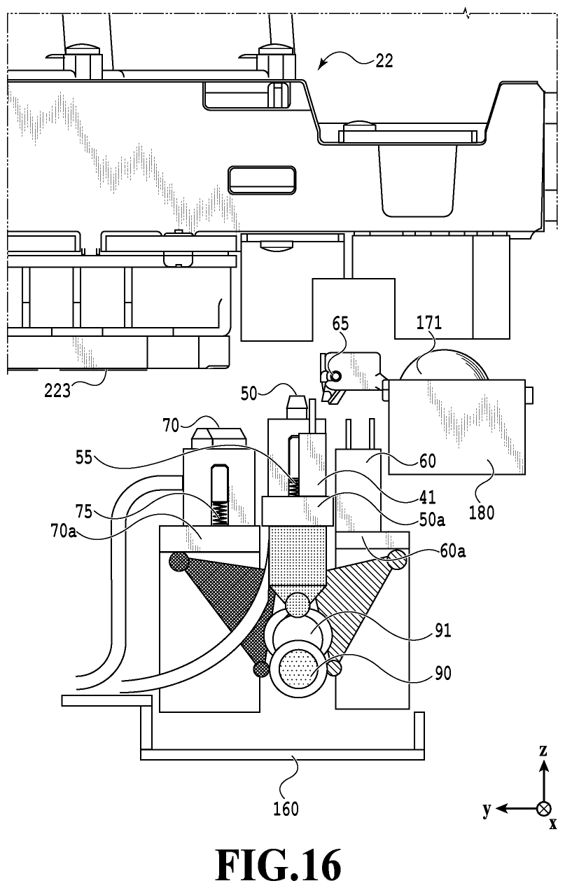

FIGS. 14 to 18 are diagrams showing a cam mechanism in a case of using a cam as an example of the elevating and lowering configuration. FIG. 15 is a perspective view showing the cam mechanism. FIGS. 16 to 18 are diagrams showing a elevating and lowering operation in a case where a cam is used as an example of the elevating and lowering configuration and the cleaning mechanism is moved to a contact height of the nozzle formation surface 223 of the printing head 22. During the elevating and lowering operation, the printing head 22 is moved and retracted in the −z direction from the printing head positioning member 171. This prevents the suction unit 70 from abutting against the nozzle formation surface 223 of the printing head 22 during the elevating and lowering operation of the first maintenance unit 40, making it possible to smoothly elevate and lower the first maintenance unit 40. Upon completion of the elevating and lowering operation of the cleaning mechanism, the retracted printing head 22 is lowered and positioned again by the printing head positioning member 171. Note that the present disclosure is not limited to this example, and the printing head 22 does not have to be retracted if the first maintenance unit 40 can be elevated and lowered smoothly.

FIG. 16 is a diagram showing a state where the cleaning liquid application unit 50 of the first maintenance unit 40 is moved to a contact position with the nozzle formation surface 223. The cleaning liquid application unit 50 can be elevated and lowered by following a first cam 91 attached to a shaft 90 provided below the first maintenance unit 40. FIG. 16 also shows a state where the second wiper unit 62 of the second maintenance unit 41 is moved to a contact position with the nozzle formation surface 223. As described above, the cleaning liquid application unit 50 and the second wiper unit 62 are provided on the same first stage 50a. Therefore, both the cleaning liquid application unit 50 and the second wiper unit 62 are elevated to a height position to perform maintenance as the first stage 50a is elevated by the first cam 91.

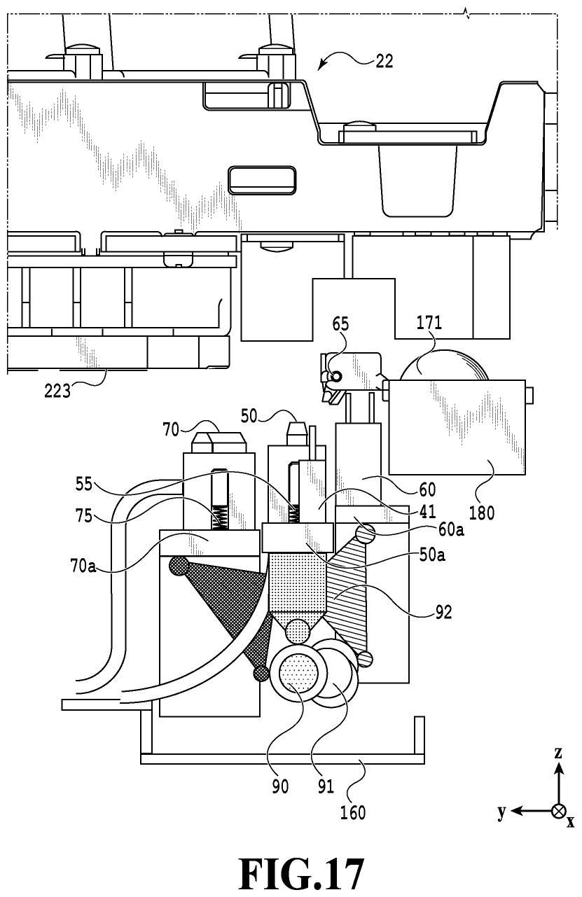

FIG. 17 is a diagram showing a state where the first wiper unit 60 of the first maintenance unit 40 is moved to a contact position with the nozzle formation surface 223. The first wiper unit 60 can be elevated and lowered by operating in conjunction with the first cam 91 attached to the shaft 90 provided below the first maintenance unit 40, and a second cam 92 disposed below the first wiper unit 60 and configured to follow the first cam 91. The first wiper unit 60 is provided on the second stage 60a. The first wiper unit 60 is elevated to a height position to perform maintenance as the second stage 60a is elevated by the first cam 91 and the second cam 92.

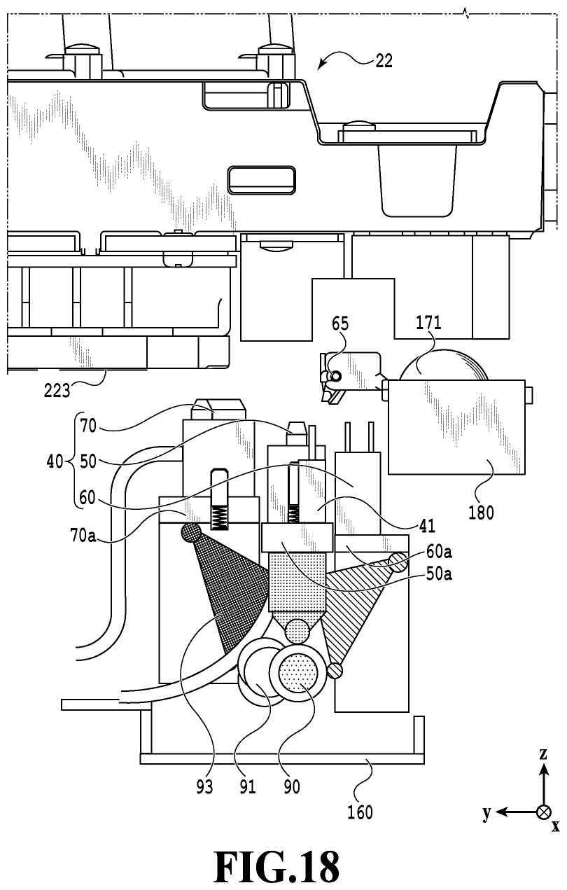

FIG. 18 is a diagram showing a state where the suction unit 70 is moved to a contact position with the nozzle formation surface 223. The suction unit 70 can be elevated and lowered by operating in conjunction with the first cam 91 attached to the shaft 90 provided below the first maintenance unit 40, and a third cam 93 disposed below the suction unit 70. The suction unit 70 is provided on the third stage 70a. The suction unit 70 is elevated to a height position to perform maintenance as the third stage 70a is elevated by the first cam 91 and the third cam 93.

Each stage is thus supported by the support member 160 configured to support the maintenance unit so as to allow scanning in the longitudinal direction of the printing head 22. The support member 160 includes a elevating and lowering mechanism (shaft and various cams) for elevating and lowering the cleaning mechanism to a first position to act on the printing head 22 and a second position to not act on the printing head 22.

In this embodiment, the elevating and lowering configuration for each maintenance unit using the first cam 91 attached to the single shaft 90 makes it possible to elevate and lower more than one mechanism part with a single driving source. This makes it possible to elevate and lower more than one cleaning mechanism in a space-saving manner.

### <Cleaning Operation Sequence Using First Maintenance Unit 40>

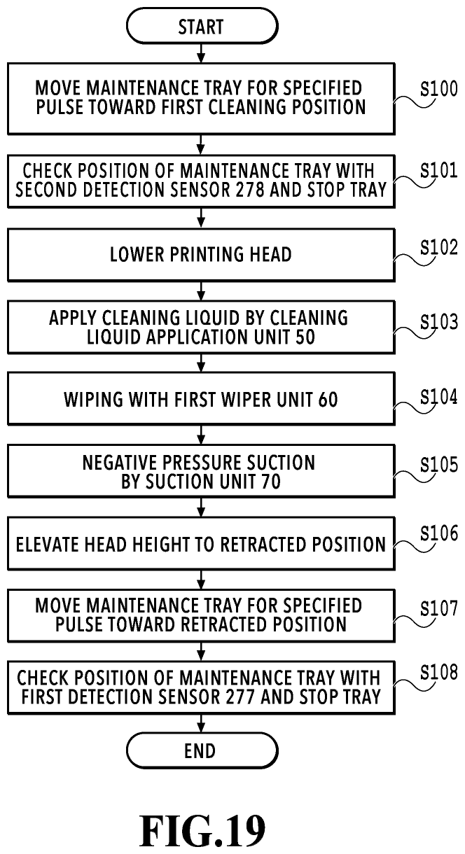

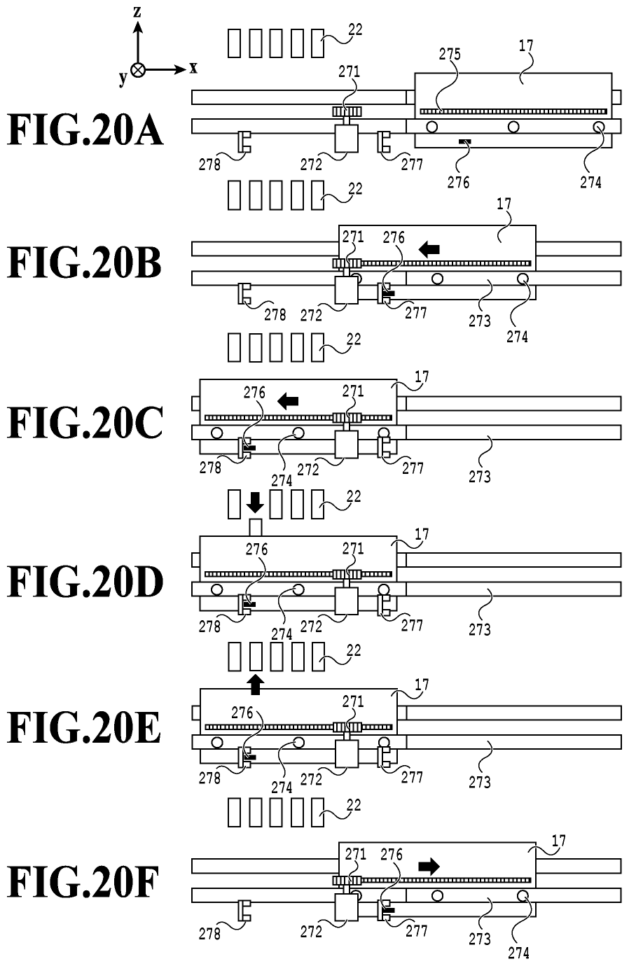

FIG. 19 is a flowchart showing an example of a head cleaning operation using the first maintenance unit 40. FIGS. 20A to 20F are diagrams showing how the maintenance tray 17 moves to the first cleaning position. The operation sequence using the first maintenance unit 40 will be described below with reference to FIGS. 19 to 20F. The processing shown in FIG. 19 is executed under the control of the control unit 21. FIG. 19 is a flowchart showing the execution flow of normal head cleaning, which is frequently executed maintenance. For convenience of explanation, FIGS. 20A to 20F show an example with five printing heads 22.

At the time of initial installation, as shown in FIG. 20A, the maintenance tray 17 is retracted from the printing heads 22, and a tray drive gear 271 as the driving source and a rack 275 are not engaged. To engage the tray drive gear 271 and the rack 275, the maintenance tray 17 is manually pushed in the −x direction. This allows roller members 274 of the maintenance tray 17 to roll within rails 273, pushing in the maintenance tray 17.

FIG. 20B shows a state where the rack 275 is engaged with the tray drive gear 271 and a flag 276 is in contact with a first detection sensor 277 near the center. This flag detection allows the control unit 21 to detect the position of the maintenance tray 17. In this state, scanning of the maintenance tray 17 can also be performed by a tray driving motor 272. The position of FIG. 20B is referred to as a tray standby position.

The processing of the flowchart shown in FIG. 19 is started in a state where the maintenance tray 17 is located in the tray standby position shown in FIG. 20B. The processing of the flowchart shown in FIG. 19 is also executed after the elapse of a certain period of time after power is turned ON, after the start of the apparatus, after predetermined printing, after the occurrence of a specific error, or the like. However, the trigger for the processing is not limited to the above. For example, the processing may be executed as the control unit 21 receives an instruction to perform maintenance on the printing head 22.

In S100, the control unit 21 moves the maintenance tray 17 for a specified pulse toward the first cleaning position. FIG. 20C shows a state where the maintenance tray 17 is further scanned in the −x direction from the tray standby position and moved until the flag 276 reaches a second detection sensor 278 at the rear left.

In S101, the control unit 21 checks the position of the maintenance tray 17 with the second detection sensor 278 and stops the movement of the maintenance tray 17. Next, in S102, the control unit 21 lowers the printing head 22 to be cleaned. FIG. 20D shows a state where the printing head 22 to be cleaned is lowered. As the printing head 22 is lowered, the positioning member 221 of the printing head 22 abuts against the head positioning member 171 in the maintenance tray 17, and positioning is completed.

Next, in S103, the control unit 21 uses the cleaning liquid application unit 50 to apply a cleaning liquid to the nozzle formation surface 223. Specifically, the cleaning liquid application unit 50 is elevated, and the cleaning liquid is applied to the nozzle formation surface 223 while moving the cleaning liquid application unit 50 in the scanning direction. Then, the applied cleaning liquid reduces the adhesion of ink sticking to the nozzle formation surface 223. Thereafter, the cleaning liquid application unit 50 is lowered to its original position, and moves in the opposite direction to the scanning direction back to the cleaning standby position.

Next, in S104, the control unit 21 uses the first wiper unit 60 to perform wiping. Specifically, the first wiper unit 60 is elevated, and the nozzle formation surface 223 is wiped while moving the first wiper unit 60 in the scanning direction. The first wiper unit 60 mainly removes sticking matter such as ink and the cleaning liquid on the nozzle guard 222, which is the convex part of the nozzle formation surface 223. Thereafter, the first wiper unit 60 is lowered to its original position, and moves in the opposite direction to the scanning direction back to the cleaning standby position.

Next, in S105, the control unit 21 uses the suction unit 70 to perform negative pressure suction. Specifically, the suction unit 70 is elevated, and the nozzle formation surface 223 is sucked by negative pressure while moving the suction unit 70 in the scanning direction. The suction unit 70 acts on the nozzle plate 224 to perform negative pressure suction, thereby removing ink sticking near the ejection port 227 and minute bubbles in the ink flow path. The suction unit 70 is then lowered to its original position, and moves in the opposite direction to the scanning direction back to the cleaning standby position.

In S106, the control unit 21 elevates the printing head 22 to the retracted position. FIG. 20E shows a state where cleaning is performed by the first maintenance unit 40 and the head is retracted after the cleaning operation is completed. After the head is retracted, the maintenance tray 17 also needs to be retracted again for printing. For this reason, in S107, the control unit 21 moves the maintenance tray 17 to the tray standby position. In S108, the control unit 21 checks the position of the maintenance tray 17 by detecting the flag 276 with the first detection sensor 277. Then, the control unit 21 stops the movement of the maintenance tray 17.

Here, the description is given of the head cleaning flow using the three cleaning mechanisms described above as the cleaning mechanisms constituting the first maintenance unit 40. However, the present disclosure is not limited to this flow. The processing of S103 and S105 may be skipped. The frequency of the execution of the processing of S103, S104, and S105 may be once or more than once. The processing of S103, S104, and S105 may be executed in a different order. The wiping direction in S103 may be one-way only or two-way.

In the processing of the flowchart in FIG. 19, as described above, the printing head 22 may be retracted to a position at a predetermined distance in the +z direction from the printing head positioning member 171 during the elevating and lowering operation of each cleaning mechanism. Specifically, the processing of FIG. 19 may include lowering the printing head 22 after moving upward and retracting the recording head 22, before the execution of cleaning by each cleaning mechanism.

### <Cleaning Operation Sequence Using Second Maintenance Unit 41>

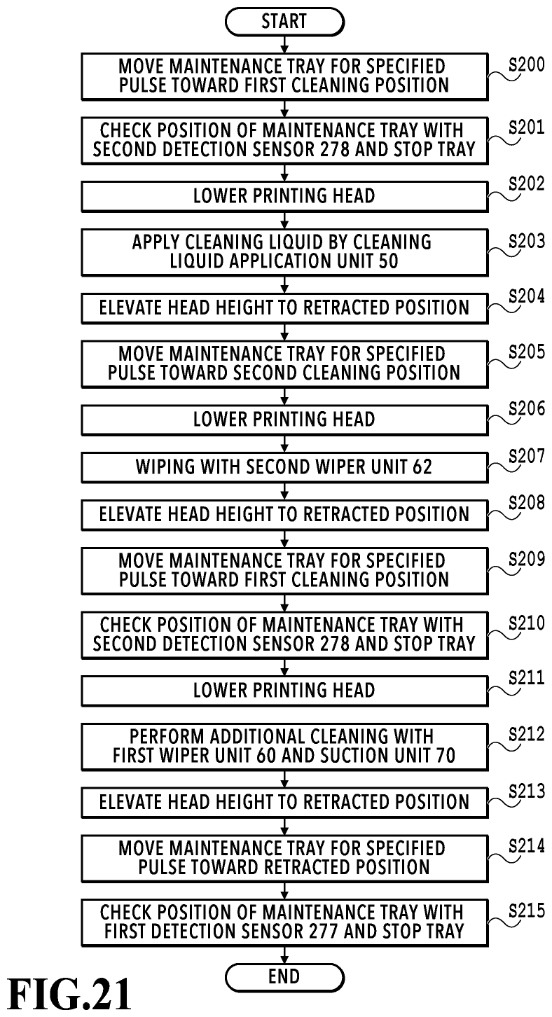

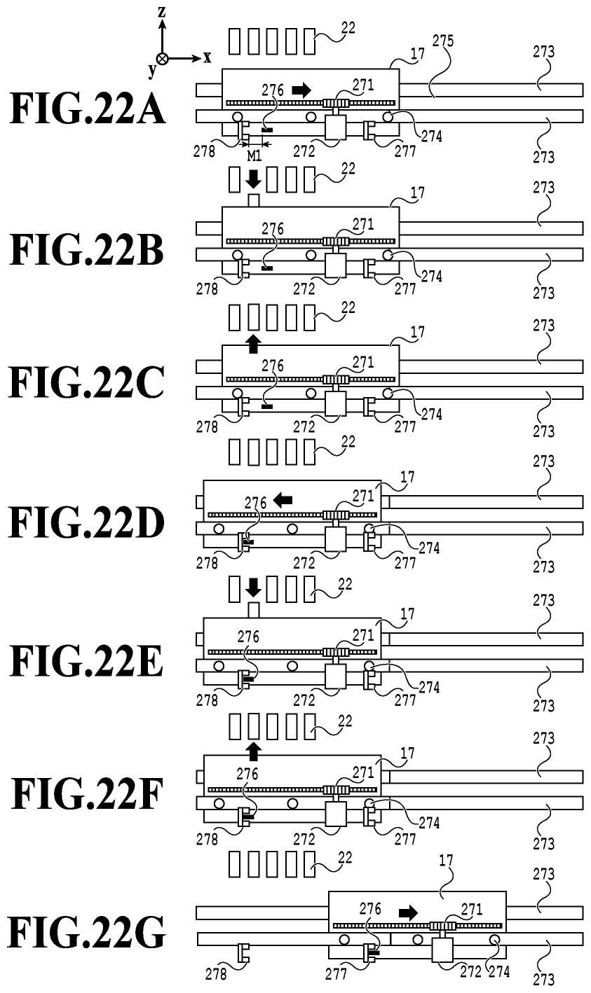

FIG. 21 is a flowchart showing an example of a head cleaning operation using the second maintenance unit 41. In the cleaning using the second maintenance unit 41, cleaning using the first maintenance unit 40 is also used in combination. FIGS. 22A to 22G are diagrams showing a state where the maintenance tray 17 moves to the first cleaning position and the second cleaning position. The operation sequence using the second maintenance unit 41 will be described below with reference to FIGS. 21 to 22G. The processing shown in FIG. 21 is executed under the control of the control unit 21. FIG. 21 is a flowchart showing the execution flow of powerful head cleaning, which is maintenance performed less frequently. That is, FIG. 21 shows the processing of cleaning using the second maintenance unit 41 in a case where the cleaning by the first maintenance unit 40 alone is insufficient. For convenience of explanation, FIGS. 22A to 22G show an example with five printing heads 22.

The processing of the flowchart shown in FIG. 21 is executed after the elapse of a certain period of time after power is turned ON, after the start of the apparatus, after predetermined printing, after the occurrence of a specific error, or the like. However, the trigger for the processing is not limited to the above. For example, the processing may be executed as the control unit 21 receives an instruction to perform maintenance on the printing head 22. However, the powerful head cleaning is intended to remove sticking ink, which is accumulated in the ejection port array 226 over time by the use of the apparatus and cannot be completely removed by normal head cleaning. For this reason, the powerful head cleaning is executed less frequently than the normal head cleaning.

The processing of S200 to S203 is the same as the processing of S100 to S103 described in FIG. 19. Specifically, in S200, the control unit 21 moves the maintenance tray 17 for a specified pulse toward the first cleaning position. In S201, the control unit 21 checks the position of the maintenance tray 17 with the second detection sensor 278 and stops the movement of the maintenance tray 17. In S202, the control unit 21 lowers the printing head 22 to be cleaned. In S203, the control unit 21 uses the cleaning liquid application unit 50 to apply the cleaning liquid to the nozzle formation surface 223. The applied cleaning liquid reduces the adhesion of the ink sticking to the nozzle formation surface 223. The cleaning liquid application unit 50 is then lowered to its original position, and moves in the opposite direction to the scanning direction back to the cleaning standby position.

In S204, the control unit 21 elevates the printing head 22 to the retracted position. In S205, the control unit 21 moves the maintenance tray 17 for a specified pulse to the second cleaning position. FIG. 22A shows a state where the maintenance tray 17 is moved to the second cleaning position. FIG. 22A shows an example where the maintenance tray 17 is moved by a movement amount M1 from the state of FIG. 20E. In this embodiment, the movement amount M1 is obtained by sending a signal to the tray driving motor 272 for the specified pulse to move the maintenance tray for the specified amount from FIG. 20E. However, the present disclosure is not limited to this example. For example, a detection sensor may be additionally provided at a position where the flag 276 reaches in FIG. 22A, and the movement amount M1 may be obtained by a method of detecting the second cleaning position, or the like.

In S206, the control unit 21 lowers the printing head 22 to be maintained. FIG. 22B shows a state where the printing head 22 is lowered and positioned.

In S207, the control unit 21 uses the second wiper unit 62 of the second maintenance unit 41 to wipe the nozzle formation surface 223. Specifically, the second wiper unit 62 is elevated, and the nozzle formation surface 223 is wiped while moving the second wiper unit 62 in the scanning direction. The wiping using the second wiper unit 62 mainly removes the sticking matter such as ink adhering to the ejection port array 226, which is the concave part of the nozzle formation surface 223. Thereafter, the second wiper unit 62 is lowered to its original position, and moves in the opposite direction to the scanning direction back to the cleaning standby position. In S208, the control unit 21 elevates the height of the printing head 22 to the retracted position. FIG. 22C shows an example where the printing head 22 is elevated.

In S209, the control unit 21 moves the maintenance tray 17 for a specified pulse toward the first cleaning position. In S210, the control unit 21 checks the position of the maintenance tray 17 with the second detection sensor and stops the movement of the maintenance tray 17. FIG. 22D is a diagram showing a state where the maintenance tray 17 has reached the first cleaning position.

In S211, the control unit 21 lowers the printing head 22. FIG. 22E is a diagram showing a state where the printing head 22 is positioned on the maintenance tray 17.

In S212, the control unit 21 performs additional wiping using the first wiper unit 60 and negative pressure suction of the printing head using the suction unit 70. The first wiper unit 60 performs wiping to remove the cleaning liquid and the like on the nozzle guard 222. The first wiper unit 60 is then lowered to its original position, and moves in the opposite direction to the scanning direction back to the cleaning standby position. Thereafter, the suction unit 70 acts on the nozzle plate 224 to perform negative pressure suction, thereby removing ink sticking near the ejection port 227 and minute bubbles in the ink flow path. The suction unit 70 is then lowered to its original position, and moves in the opposite direction to the scanning direction back to the cleaning standby position.

In S213, the control unit 21 elevates the printing head 22 to the retracted position. FIG. 22F is a diagram showing a state where the printing head 22 is elevated.

In S214, the control unit 21 moves the maintenance tray 17 for a specified pulse toward the retracted position. In S215, the control unit 21 checks the position of the maintenance tray 17 with the first detection sensor 277 and stops the maintenance tray 17. FIG. 22G shows a state where the maintenance tray 17 is located at the tray standby position.

Here, the description is given of the cleaning flow in which the three cleaning mechanisms described above are used as the cleaning mechanism constituting the first maintenance unit 40, and one cleaning mechanism is used as the cleaning mechanism constituting the second maintenance unit 41. However, the present disclosure is not limited to such processing. The frequency of the execution of the processing of S203, S207, and S210 may be once or more than once. The processing of S203, S207, and S210 may be executed in a different order. The wiping direction in S203 and S210 may be one-way only or two-way.

In the processing of the flowchart in FIG. 21, as described above, the printing head 22 may be moved upward and retracted to a position at a predetermined distance in the +z direction from the printing head positioning member 171 during the elevating and lowering operation of each cleaning mechanism. Specifically, the processing of FIG. 21 may include lowering the printing head 22 after moving upward and retracting the recording head 22, before the execution of cleaning by each cleaning mechanism.

As described above, according to the present disclosure, the cleaning members can be arranged without increasing the size of the apparatus. Specifically, according to the present disclosure, more cleaning mechanisms can be arranged within a limited space in the scanning direction in which the cleaning mechanisms scan, and the apparatus can be reduced in size.

### Second Embodiment

In the first embodiment, the description is given of the example where the first cam 91 configured to elevate and lower the cleaning liquid application unit 50 is used, as shown in FIG. 16, in the elevating and lowering operation of the second maintenance unit 41. In a case of using the first cam 91 to elevating and lowering the second maintenance unit 41, the elevating and lowering amount is the same as that of the cleaning liquid application unit 50. Therefore, in order to implement the optimal elevating and lowering position of the second maintenance unit 41, a position adjustment member may be required to adjust the position of the unit in the z direction. In this embodiment, description is given of an example where a fourth cam with a different arrangement or shape is used on the shaft where the first cam 91 is operated in the elevating and lowering operation of the second maintenance unit 41.

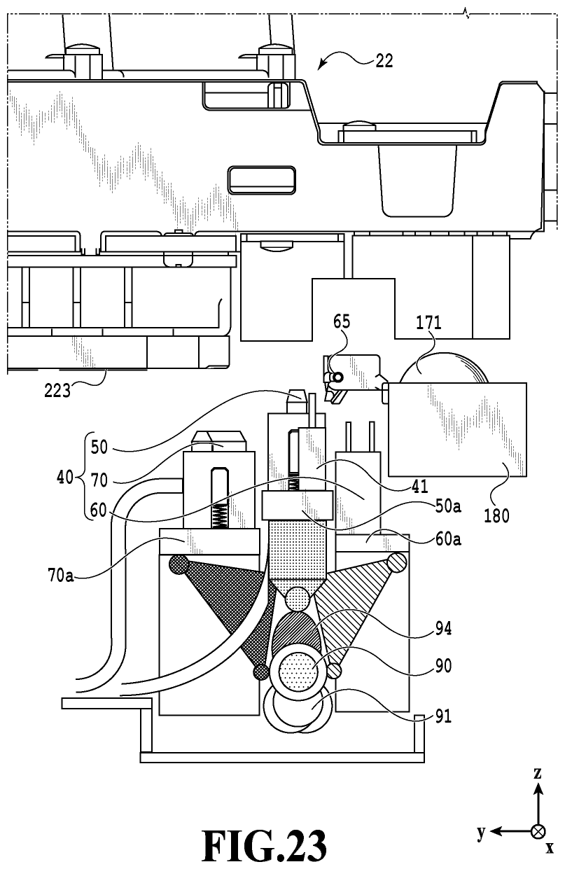

FIG. 23 is a diagram showing a state where the second maintenance unit 41 is moved to a contact position with the nozzle formation surface 223. FIG. 23 shows a state where the second maintenance unit 41 is moved by the fourth cam 94 to the contact position with the nozzle formation surface 223. Since the fourth cam 94 also acts on the first stage 50a, the cleaning liquid application unit 50 of the first maintenance unit 40 is also elevated.

The fourth cam 94 is misaligned in the x direction from the first cam 91, and has a different elevating and lowering amount from the first cam 91. The use of such a configuration makes it possible to make the elevating and lowering amount (movement amount) in a case of elevating and lowering the cleaning liquid application unit 50, which is provided on the same stage, different from the elevating and lowering amount (movement amount) for elevating and lowering the second maintenance unit 41. This makes it possible to implement an optimal elevating and lowering amount for the second maintenance unit 41. The removal power of the nozzle formation surface 223 can thus be further improved. There is also no need to provide a position adjustment member for adjusting the position of the unit in the z direction.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A maintenance mechanism comprising:
a first maintenance unit provided with a plurality of cleaning mechanisms for cleaning a printing head configured to eject a liquid;
a second maintenance unit provided with a cleaning mechanism different from the cleaning mechanisms provided in the first maintenance unit and disposed side by side with the first maintenance unit in a transverse direction of the printing head;
a support member configured to support the first maintenance unit and the second maintenance unit so as to allow scanning in a longitudinal direction of the printing head;
a first positioning member configured to position the printing head at a first cleaning position; and
a second positioning member configured to position the printing head at a second cleaning position that is different from the first cleaning position in the transverse direction of the printing head.

2. The maintenance mechanism according to claim 1, wherein the maintenance mechanism can move in a horizontal direction,
the maintenance mechanism moves to the first cleaning position in a case of performing cleaning of the printing head by the first maintenance unit, and
the maintenance mechanism moves to the second cleaning position in a case of performing cleaning of the printing head by the second maintenance unit.

3. The maintenance mechanism according to claim 1, wherein the support member includes a elevating and lowering mechanism configured to elevate and lower the cleaning mechanism between a first position for acting on the printing head and a second position for not acting on the printing head.

4. The maintenance mechanism according to claim 3, wherein, in a case when the second maintenance unit moves to the first position, some of the plurality of cleaning mechanisms in the first maintenance unit move from the second position.

5. The maintenance mechanism according to claim 4, wherein, in a case when the second maintenance unit moves to the first position, some of the plurality of cleaning mechanisms in the first maintenance unit also move to the first position.

6. The maintenance mechanism according to claim 4, wherein a movement amount in a case where the second maintenance unit moves from the second position to the first position is the same as a movement amount in a case where some of the plurality of cleaning mechanisms in the first maintenance unit move from the second position to the first position.

7. The maintenance mechanism according to claim 4, wherein a movement amount in a case where the second maintenance unit moves from the second position to the first position is different from a movement amount in a case where some of the plurality of cleaning mechanisms in the first maintenance unit move from the second position to the first position.

8. The maintenance mechanism according to claim 1, wherein the plurality of cleaning mechanisms in the first maintenance unit are arranged side by side in the longitudinal direction of the printing head.

9. The maintenance mechanism according to claim 1, wherein some of the plurality of cleaning mechanisms in the first maintenance unit are a first wiper unit configured to remove the liquid on a nozzle formation surface of the printing head, and
the cleaning mechanism in the second maintenance unit is a second wiper unit configured to remove the liquid on the nozzle formation surface of the printing head.

10. The maintenance mechanism according to claim 9, wherein the nozzle formation surface of the printing head includes an ejection port array in which ejection ports for ejecting the liquid are arranged, and a nozzle guard covering the ejection port array,
the first wiper unit removes the liquid on the nozzle guard, and
the second wiper unit removes the liquid on the ejection port array.

11. The maintenance mechanism according to claim 9, wherein the second wiper unit performs cleaning in both forward and backward directions in the longitudinal direction of the printing head.

12. The maintenance mechanism according to claim 1, wherein the first positioning member and the second positioning member are members of the same shape,
the first positioning member and the second positioning member are both provided with a plurality of members at an end of the printing head in the longitudinal direction, and
a pitch between the plurality of members in the first positioning member at the end is different from a pitch between the plurality of members in the second positioning member.

13. The maintenance mechanism according to claim 1, further comprising a detection unit capable of detecting the first cleaning position and the second cleaning position.

14. The maintenance mechanism according to claim 1, wherein the first maintenance unit and the second maintenance unit are provided for each printing head,
the first maintenance unit and the second maintenance unit are arranged alternately in the transverse direction of the printing head, and
the first positioning member and the second positioning member are arranged alternately in the transverse direction of the printing head.

15. A liquid ejection apparatus comprising:
a printing head configured to eject a liquid; and
a maintenance mechanism including:
a first maintenance unit provided with a plurality of cleaning mechanisms for cleaning the printing head;
a second maintenance unit provided with a cleaning mechanism different from the cleaning mechanisms provided in the first maintenance unit and disposed side by side with the first maintenance unit in a transverse direction of the printing head;
a support member configured to support the first maintenance unit and the second maintenance unit so as to allow scanning in a longitudinal direction of the printing head;
a first positioning member configured to position the printing head at a first cleaning position; and
a second positioning member configured to position the printing head at a second cleaning position that is different from the first cleaning position in the transverse direction of the printing head.

16. A maintenance method for a liquid ejection apparatus, the method comprising:
positioning a printing head configured to eject a liquid at a first cleaning position;
performing first maintenance of the printing head positioned at the first cleaning position by a first maintenance unit including a plurality of cleaning mechanisms;
positioning the printing head subjected to the first maintenance at a second cleaning position that is different from the first cleaning position in a transverse direction of the printing head;
performing second maintenance of the printing head subjected to the first maintenance and positioned at the second cleaning position by a second maintenance unit including a cleaning mechanism different from the cleaning mechanisms included in the first maintenance unit;
positioning the printing head subjected to the second maintenance at the first cleaning position; and
performing third maintenance of the printing head subjected to the second maintenance and positioned at the first cleaning position by the first maintenance unit.
